(19) United States
(12) Patent Application Publication
(10) Pub. No.: US 2024/0266106 A1
(43) Pub. Date: Aug. 8, 2024

(54) VIA-BASED INDUCTOR COIL FOR INTEGRATED SILICON APPLICATIONS

(71) Applicant: NVIDIA Corp., Santa Clara, CA (US)

(72) Inventors: Joseph Minacapelli, Sunnyvale, CA (US); Cong Gao, Pflugerville, TX (US)

(73) Assignee: NVIDIA Corp., Santa Clara, CA (US)

(21) Appl. No.: 18/165,874

(22) Filed: Feb. 7, 2023

(51) Int. Cl. H01F 27/30

(52) U.S. Cl. CPC H01F 27/306

(57) ABSTRACT

Integrated inductors are formed by arranging multiple vias to bracket a volume of semiconductor substrate, where each via includes a top metal pad and a bottom metal pad. The vias are alternately connected by way of the top and bottom pads to form an end-to-end current loop along a length of the volume of semiconductor substrate.

### BACKGROUND

Integrated circuits often locate inductors in close proximity to transistors. Traditionally these inductors have been either discrete components (e.g., surface-mounted elements) that are added to after the transistors are fabricated, or integrated (into the silicon wafer itself) two-dimensional (2D) structures that are formed as a spiral structure during wafer fabrication.

The addition of discrete inductors introduces parasitic effects in the circuit and adds cost to manufacturing, lowers reliability, and lowers yield in many cases. Two-dimensional integrated inductors are limited as to the size of inductance that may be achieved. A 2D spiral structure is often too small to generate the inductance needed for practical applications.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an idealized inductor structure 100.

FIG. 2 depicts an inductor fabrication process 200 in accordance with one embodiment.

FIG. 3 depicts a perspective view of a three-turn via-based integrated inductor structure 300 in accordance with one embodiment.

FIG. 4 depicts a plan view of a five-turn via-based integrated inductor structure 400 in accordance with one embodiment.

FIG. 5A depicts another embodiment of an integrated inductor structure.

FIG. 5B depicts yet another embodiment of an integrated inductor structure.

FIG. 5C depicts yet another embodiment of an integrated inductor structure.

### DETAILED DESCRIPTION

Disclosed herein are mechanisms utilizing vias to implement a three-dimensional (3D) silicon integrated inductor structure. These mechanisms may utilize common through-substrate structures such as vias, micro-vias, and/or plated through holes. These structures and similar ones, known in the art, are referred to collectively herein as through-silicon vias (TSVs) or just “vias”. Vias typically connect to pads and traces on each layer, formed through common metal deposition, plating, and etching techniques, in order to carry electrical signals from one layer to another.

Holes may be etched or drilled through the silicon substrate, then an oxide liner or other non-conductive material may be deposited to insulate the substrate from the conductive material (such as metal) that is then deposited within the hole. A silicon substrate process such as this enables fine sizing, spacing, pitch, width, etc., of circuit elements. Mechanisms described herein utilize TSVs to form 3D inductor structures. These structures may provide a larger inductance value than may be achieved by inductors formed using other integrated methods, such as two-dimensional spiral inductors, while consuming less surface area of the substrate.

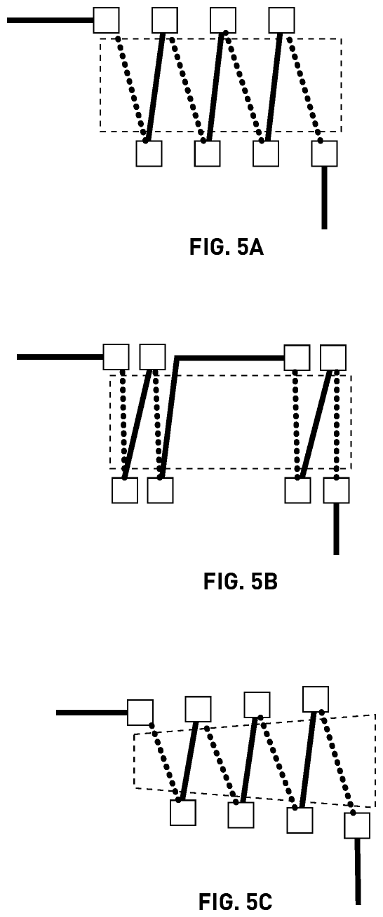

In one aspect, a plurality of vias are formed a semiconductor substrate such that the vias “bracket” a volume of substrate material (the “core material” of the inductor). By “bracket”, it is meant that the vias are arranged along two opposite sides of a distal length of the core material. The opposite sides may typically be parallel, meaning the vias are arranged into two parallel rows, although this need not be the case in all embodiments (e.g., see FIG. 5C). Traces (i.e., metal connections) are configured between top pads of the vias and between bottom pads of the vias to form a continuous path for current to flow circumferentially from a first end of the core material to a second end of the core material. “Circumferentially” is not intended to mean circularly; rather, “circumferential” flow of current should be understood herein to mean that the traces create a path for current to flow both around and along a distal length of the periphery of the core volume. In practice this can mean the current flow is alternately across a first surface of the core volume via traces, then down to a second surface of the core volume by way of the vias, then across the second surface of the core volume via traces on the second side, and so on.

An inductor formed in this manner may includes a plurality of vias bracketing a volume of semiconductor substrate, each via including a top metal pad and a bottom metal pad, with the vias alternately connected by way of the top metal pads and the bottom metal pads to form an end-to-end current “loop” (which is typically not circular in shape) along a length of the volume of semiconductor substrate. The bracketed volume may be prism-shaped volume, and in some embodiments may more specifically be a rectangular-shaped volume.

In one aspect, a semiconductor substrate includes a volume of substrate material bordered by two rows of vias, and metal traces configured between the vias to form a coil along a length of the volume of substrate material. The “coil” may typically not be strictly circular, but rather comprise a series of right-angle turns in three dimensions.

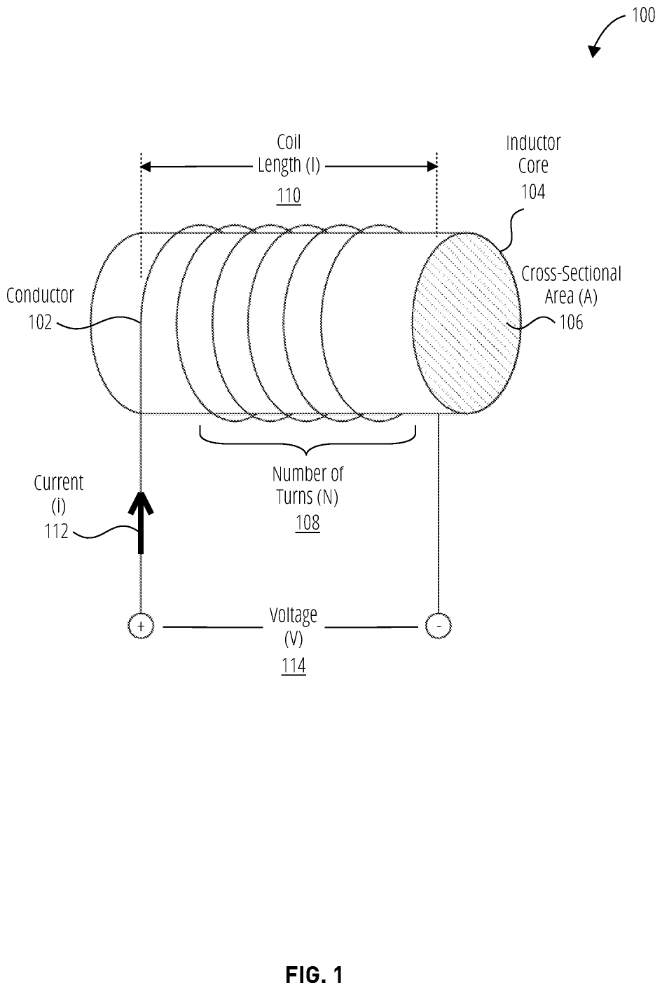

FIG. 1 depicts an idealized inductor structure 100. The idealized inductor structure 100 comprises a conductor 102 wrapped around an inductor core 104, where the conductor 102 is a conductor of electricity such as a metal wire or ribbon and the inductor core 104 comprises semiconductor substrate material comprising material properties sufficient to generate a desired magnetic response to current flowing through the conductor 102. The conductor 102 may be coated with insulative material preventing the conductor 102 from shorting to itself or to the inductor core 104.

The inductor core 104 may have a cross-sectional area 106 “A” around which the conductor 102 is wrapped in a number of turns 108 “N”, forming a coil having coil length 110 “l”. A current 112 “i” flowing through the conductor 102 of the inductor coil may induce a time-dependent voltage 114 “V” response across the ends of the conductor 102. This voltage 114 may be expressed as:

$$V ( t ) = {L}_{coil} \times \frac{di}{dt}$$

where V(t) is the voltage in volts at time t, L_{coil} is the inductance of the coil in Henries (H), and di/dt is the rate of change of the current in time.

Inductance L_{coil} is proportional to the cross-sectional area of the inductor coil. The inductance of an inductor structure may be approximately determined from the following classical equation:

$${l}_{coil} = \frac{{μ}_{r} {μ}_{0} {N}^{2} A}{l}$$

where:
L_{coil}=inductance of the coil in Henries (H)
μᵣ=relative permeability of the inductor core material (dimensionless)
μ₀=permeability of free space=4π×10⁻⁷ (H/m)
N=Number of turns
A=coil cross-sectional area (m²)
l=coil length

For a cylindrical inductor, the coil cross-sectional area A=πr² where r is the radius of the coil in meters (m).

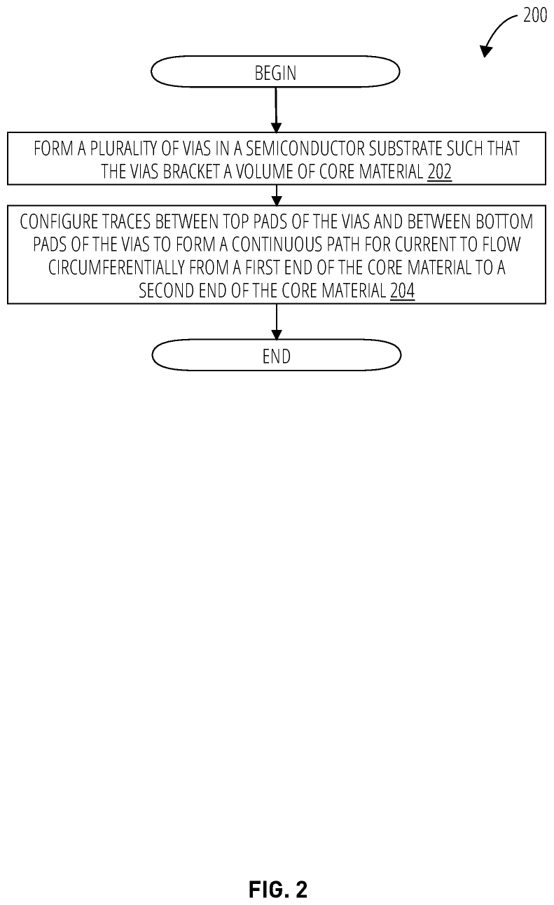

FIG. 2 depicts an inductor fabrication process 200 in one embodiment. A plurality of vias are formed (block 202) in a semiconductor substrate such that the vias bracket a volume of core material. This volume may be a prism, or more specifically a rectangular volume. The vias may be arranged into parallel rows, and within each row may be evenly or unevenly spaced from one another. Traces (which may be stacked metal traces) are formed between top pads of the vias (typically also metal) and between bottom pads of the vias to form a continuous (unbroken) path for current to flow circumferentially from a first end of the core material to a second end of the core material. Again, “circumferentially” does not literally mean circular; the path of the current flow may in practice traverse a series of right angles, for example.

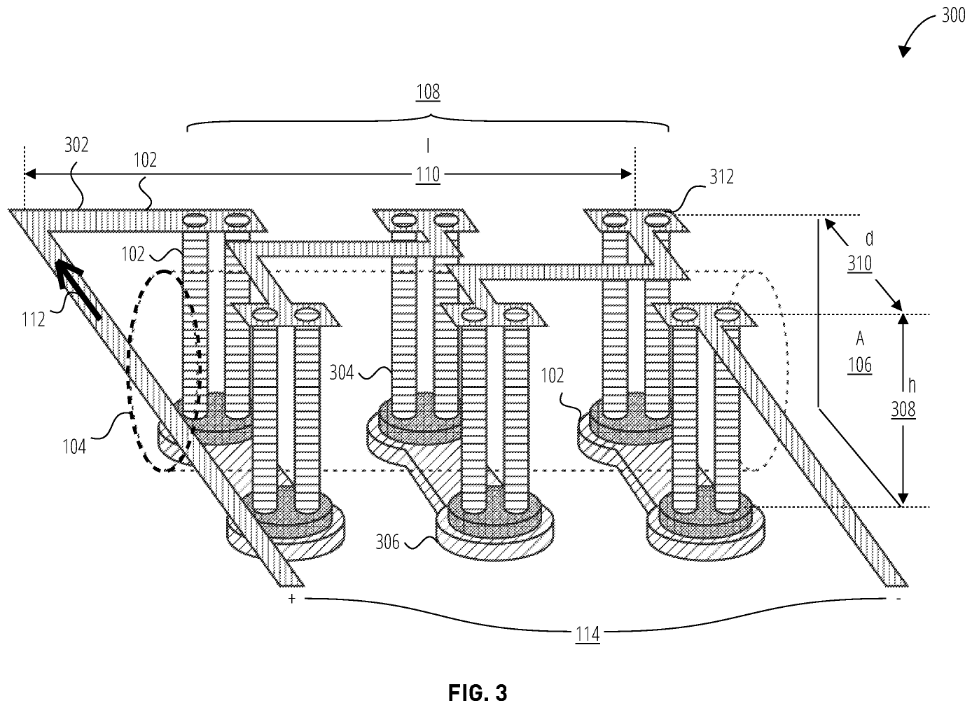

FIG. 3 depicts a perspective view of a three-turn via-based integrated inductor structure 300 in accordance with one embodiment. A configuration of top-side traces 302, vias 304 passing through the substrate, back-side traces 406, and second-layer pads 306 form the conductor 102 of the inductor coil. Similar to the above-discussed insulation of the metal deposited within holes etched to form the vias 304, oxide layers may separate the top-side traces 302, back-side traces 406, and second-layer pads 306, from the inductor core 104.

The interstitial space between these conductive structures in three dimensions may be filled with a material (e.g., silicon) comprising the inductor core 104. (The relative permeability of silicon is 0.99837.) The inductor core 104 is depicted as cylindrical to illustrate the commonality with the idealized inductor structure 100. However, the cross-sectional area 106 of the three-turn via-based integrated inductor structure 300 may be determined by the area bounded by the top-side traces 302, vias 304, back-side traces 406, and second-layer pads 306, and may in fact be closer to rectangular than cylindrical. The conductive structures may extend for a coil height 308 and across a coil depth 310, making the cross-sectional area 106 the product of these two parameters.

The configuration of the top-side traces 302, vias 304, back-side traces 406, and second-layer pads 306 may form a number of turns 108, such as the three turns depicted. The start and end points of these turns may determine the coil length 110 as shown. Current 112 may be applied to a trace at one end of the coil, such as the top-side trace 302, flow through one or more vias 304, and exit the other end. Each TSV may comprise a plurality of vias (e.g., pairs as depicted, or three, or four) to reduce the parasitic resistance (Rdc) encountered by the current 112 due to the material properties and physical configuration of these conductive structures. A grouping of two or more vias in this fashion is referred to herein as a “via cluster”.

The current 112 traverses the top-side traces 302 on a first circuit substrate layer to first-layer pads 312, through the vias 304 to a second layer via the second-layer pads 306. From there the current 112 traverses the back-side traces 406, through the second-layer pads 306 to the vias 304 for return to the first layer, thereby forming a single turn of the coil.

In this manner the via 304 may be understood to be alternately connected to one another by way of their first-layer pads 312 and second-layer pads 306.

By way of example, the top-side trace 302 may by a stacked trace (as understood in the art) having a width of 12 μm and a thickness of 2 μm times the number of trace thicknesses stacked. Stacked trace structures may be used to reduce the parasitic resistance effects of the top-side trace 302 structures. For a stacked top-side trace 302 that includes four layers of 2 μm of metal deposition, the trace conductive thickness would be 8 μm (oxide layers may reside between each deposited metal layer, but the effective conductive properties would depend on the overall conductive cross-section).

By way of example, the back-side trace 406 may be a metal backside (MBS) trace that is 57 μm wide and 4 μm thick. The second-layer pad 306 may have a diameter of 57 μm and be 4 μm thick. The via 304 may have a diameter of 12 μm and be 50 μm high. In such an embodiment, the coil height 308 would then be 50 μm, with the coil length 110 and coil depth 310 determined by the spacing of the via pairs in the horizontal plane. It may be readily understood by one of ordinary skill in the art how the vias forming the 3D inductor structure may be spaced to allow the presence of additional structures in the silicon as determined by the overall design requirements.

The small dimensions achievable to this process enable a greater number of turns to be configured within a given physical area of the silicon substrate. As shown by the equation for inductance above, the more turns that may be configured within a coil length, the higher the inductance achievable within a given volume and corresponding area.

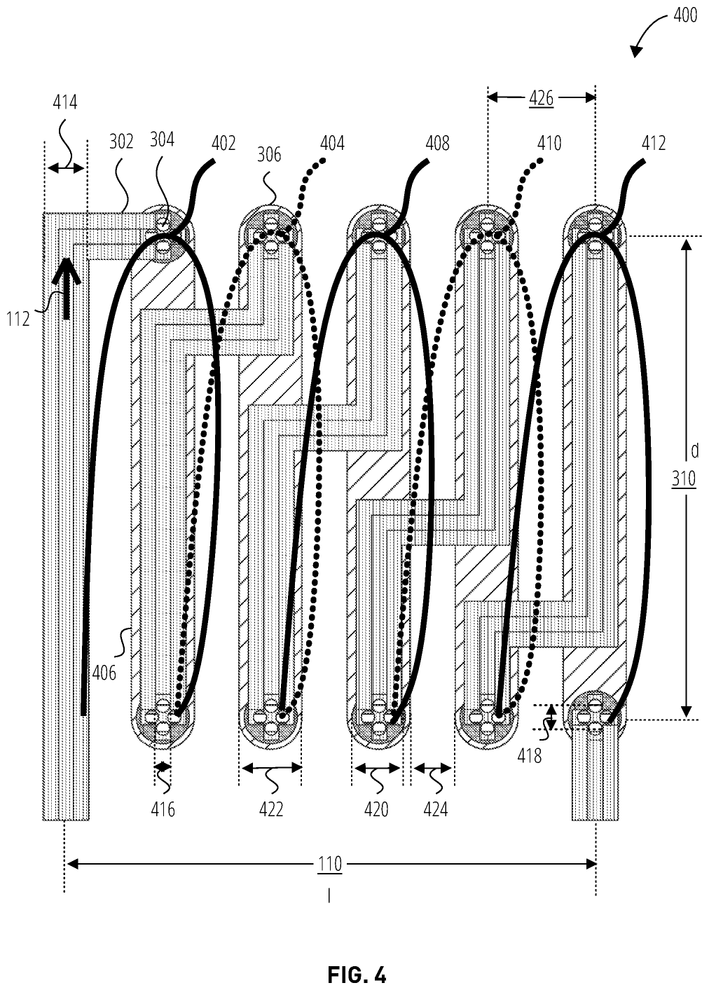

FIG. 4 depicts a plan view five-turn via-based integrated inductor structure 400 in accordance with one embodiment. The top-side traces 302 are triple-stacked together and electrically coupled to vias 304 in a quad configuration, wherein four via 304 are utilized for each cross-layer connection. This configuration may achieve low parasitic resistance and sufficient inductance within the constraints of the fabrication processes utilized for advanced process nodes. This embodiment should not be understood to limit the scope of the disclosed mechanisms to a particular trace stack depth or via grouping number.

The quad-arranged vias 304 may pass through the substrate to connect the top-side traces 302 to second-layer pads 306 on a different layer. The second-layer pads 306 may be connected by back-side traces 406. In this manner, current 112 may travel through turn 1 402, turn 2 404, turn 3 408, turn 4 410, and turn 5 412 of the five-turn via-based integrated inductor structure 400, as indicated.

By way of example, the triple top-side trace width 414 may be 40 μm. Each via 304 of the quad via arrangements may have a via diameter 416 of 12 μm. The vias 304 may be arranged in quad via configurations with a via pitch 418 of 20 μm. The back-side traces 406 and second-layer pads 306 may have a back-side pad and trace width 422 of 57 μm. The back-side traces 406 may have a back-side pad and trace spacing 424 of 10 μm (note that this is not depicted to scale). The quad vias along each side of the coil may have a quad via pitch 426 of 67 μm.

In such an embodiment, the coil length 110 1 would be 335 μm. The coil depth 310 d may be 536 μm. Where the vias 304 have the height of 50 μm as shown in FIG. 3, the coil height 308 h would be 50 μm, and the cross sectional area A would be d×h. With the conductors arranged as a five-turn via-based integrated inductor structure 400, N would be 5, and with silicon acting as the inductor core, μᵣ=0.99837. The five-turn via-based integrated inductor structure 400 configured thus would achieve an inductance of:

$${L}_{coil} = \frac{{μ}_{r} {μ}_{0} {N}^{2} A}{l} = \frac{0.99837 \times 4 π \times {10}^{- 7} \times {5}^{2} \times 0.000536 \times 0.00005}{0.000335} ≅ 2.5 nH$$

within an area of less than 0.2 mm².

FIG. 5A, FIG. 5B, and FIG. 5C depict alternate embodiments of an integrated inductor. The inductor core material is depicted as a light dashed quadrilateral, the top-side via pads are depicted as solid rectangles, the top-side traces as heavy solid lines, and the bottom-side traces as heavy dotted lines. For simplicity the traces are depicted at acute angles but due to fabrication constraints may in practice be formed using one or more right-angle turns.

In the example embodiments of FIG. 3 and FIG. 4, the vias are configured directly across from one another in relation to the core material, and are distributed at regular intervals along the core length. In the embodiment of FIG. 5A the vias on opposite sides of the core material are offset from one other, and in FIG. 5B the vias are not distributed along the core length at regular intervals. In FIG. 5C, the vias are arranged along a grade (more generally, they have an irregular spacing across from one another). This effectively forms an inductor with a tapered core shape.

These alternatives may deliver the benefits described previously while enabling layout flexibility for other components in the vicinity of the integrated inductor structure. These alternatives may also provide some flexibility to control the distribution of magnetic flux density generated by the inductor.

### LISTING OF DRAWING ELEMENTS

100 idealized inductor structure
102 conductor
104 inductor core
106 cross-sectional area
108 number of turns
110 coil length
112 current
114 voltage
200 inductor fabrication process
202 block
204 block
300 three-turn via-based integrated inductor structure
302 top-side trace
304 via
306 second-layer pad
308 coil height
310 coil depth
312 first-layer pad
400 five-turn via-based integrated inductor structure
402 turn 1
404 turn 2
406 back-side trace
408 turn 3
410 turn 4
412 turn 5
414 top-side trace width
416 via diameter
418 via pitch
420 insulated opening diameter
422 back-side pad and trace width
424 back-side pad and trace spacing
426 quad via pitch

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A method comprising:
forming a plurality of vias in a semiconductor substrate such that the vias bracket a volume of core material; and
configuring traces between top pads of the vias and between bottom pads of the vias to form a continuous path for current to flow circumferentially from a first end of the core material to a second end of the core material.

2. The method of claim 1, wherein the vias are formed into two parallel rows.

3. The method of claim 1, wherein the volume of core material is a prism.

4. The method of claim 1, wherein the volume of core material is a rectangular volume.

5. The method of claim 1, wherein the vias have a regular spacing.

6. The method of claim 1, wherein the traces comprise only right-angle turns.

7. The method of claim 1, wherein the vias are grouped into via clusters.

8. The method of claim 7, wherein the via clusters consist of pairs of vias.

9. The method of claim 7, wherein the via clusters consist of quads of vias.

10. A semiconductor substrate comprising:
a volume of substrate material bordered by two rows of vias; and
metal traces configured between the vias to form a coil along a length of the volume of substrate material.

11. The semiconductor substrate of claim 10, wherein the vias are evenly spaced in parallel rows.

12. The semiconductor substrate of claim 10 wherein the volume of substrate is rectangular.

13. The semiconductor substrate of claim 10, wherein any turns in the metal traces are right angle turns.

14. An inductor comprising:
a plurality of vias bracketing volume of semiconductor substrate, each via comprising a top metal pad and a bottom metal pad; and
the vias alternately connected by way of the top metal pads and the bottom metal pads to form an end-to-end current loop along a length of the volume of semiconductor substrate.

15. The inductor of claim 14, wherein the vias are arranged in two parallel rows.

16. The inductor of claim 15, wherein the vias in each row have a regular spacing.

17. The inductor of claim 14, wherein the volume of core material is a rectangular prism.

18. The inductor of claim 14, wherein the vias are connected by exclusively right-angle traces.

19. The inductor of claim 18, wherein the traces are stacked traces.

20. The method of claim 1, wherein the vias are via clusters.
